(19) United States
(12) Patent Application Publication
(10) Pub. No.: US 2017/0237908 A1
(43) Pub. Date: Aug. 17, 2017

(54) 360 DEGREE IMAGE CAPTURE APPARATUS ENCLOSED IN A BALL-SHAPE HOUSING

(71) Applicant: MEMORA INC., Palo Alto, CA (US)

(72) Inventors: Ju-Chun KO, Yonghe City (TW); Shang-Fon CHIANG, Taipei City (TW)

(21) Appl. No.: 15/269,796

(22) Filed: Sep. 19, 2016

Related U.S. Application Data
(60) Provisional application No. 62/295,465, filed on Feb. 15, 2016.

(30) Foreign Application Priority Data
Mar. 18, 2016 (DE) 202016001778.1

(51) Int. Cl. H04N 5/247; H04N 5/225

(52) U.S. Cl. CPC H04N 5/247; H04N 5/2252

(57) ABSTRACT

The present invention relates to an image capture apparatus includes a substantially spherical housing and two cameras. The apparatus resembles a billiard ball by and large, and could roll or rotate to an extent with the spherical housing. Meanwhile the housing has a small flat bottom, so that the image capture apparatus can stand still with the flat bottom on a plane surface. The two cameras are positioned above the flat bottom and substantially opposite to each other in the housing and point substantially horizontally with the flat bottom.

### CROSS REFERENCE TO RELATED APPLICATIONS

This Application claims priority of U.S. Provisional Application No. 62/295,465, filed on Feb. 15, 2016, and claims priority of German Patent Application No. 202016001778.1, filed on Mar. 18, 2016, the entirety of which are incorporated by reference herein.

### BACKGROUND OF THE INVENTION

1. Field of the Invention

The present invention has generally to do with static or video camera apparatus enclosed in a ball-shape housing or shell, so that the apparatus could roll or rotate to an extent while taking pictures or videos in motion. Meanwhile, with a small flat bottom, the apparatus can stand still on the table or on the ground if needed.

2. Description of Related Art

Please refer to US20130210563 and Ricoh Theta S camera, for example. Particularly, US20130210563 provides conventional ball-shaped cameras designed to be thrown or projected into an airborne trajectory.

### SUMMARY OF THE INVENTION

The present invention first realizes that, although the ball shape provides several advantages for a camera device, particularly for a 360 degree camera device, a complete ball shape object has the problem being fixed in a position without other fixing or supporting gears such as a pod, and thus it is difficult for the conventional ball-shape cameras to take stable pictures or videos. It is also impractical to require the user to always carry a pod with the camera.

According to the present invention and in response to the need as identified above, an image capture apparatus is equipped with a substantially spherical housing and at least two cameras. Compared with a complete ball shape (i.e., as taught by the prior arts), the present invention provides a small flat cut on the spherical housing as a bottom. Maybe causing imperfect aerodynamic performance with the flat cut as to be avoided by the prior art US20130210563, the presented image capture apparatus gains benefits by easy standing still on a table with the flat bottom, without the need of any additional fixing or supporting gears. This advantage strongly encourages the user to use the presented image capture apparatus in daily life or in ad hoc because the user does not need to carry a pod.

Meanwhile, because the flat bottom is relatively small, making the presented image capture apparatus still resembles a billiard ball by and large, it is still able to keep advantages provided from the ball shape. For example, the presented image capture apparatus could be rolled or rotated with its spherical surface while taking pictures with one or multiple cameras as equipped, which is beneficial to create 360 degree pictures or videos in some circumstances.

In another aspect, to less interfere with the spherical surface, the present invention can make good use of the area of the flat bottom. For example, data I/O ports or electrical contacts for power charging could be arranged at the flat bottom area. It is also easier from the perspective of manufacturing. Meanwhile attaching devices such as connection holes or grooves or magnetic connectors could be provided at or around the flat bottom, so that the presented image capture apparatus, when needed, could still be attached to a tripod or to a refrigerator door, for example.

In one embodiment of the invention, an image capture apparatus includes:
a substantially spherical housing, wherein the housing has a flat bottom, so that the image capture apparatus can stand still with the flat bottom on a plane surface, and the area of the flat bottom is smaller than ¼ or preferably smaller than 1/9 the largest cross section of the housing; and
two cameras positioned above the flat bottom and substantially opposite to each other in the housing and pointing substantially horizontally with the flat bottom. Optionally, the two cameras each has a fish-eye lens, and the sum of the field of view of the two cameras is at least 360°. For example, each fish-eye lens has the field of view of 190°.

The following description, the appended claims, and the embodiments of the present invention further illustrate the features and advantages of the present invention.

### BRIEF DESCRIPTION OF THE DRAWINGS

FIG. 1 is the front view of the image capture apparatus according to an exemplary embodiment of the present invention;

FIG. 2 is the back view of the image capture apparatus according to an exemplary embodiment of the present invention;

FIG. 3 is the left view of the image capture apparatus according to an exemplary embodiment of the present invention;

FIG. 4 is the right view of the image capture apparatus according to an exemplary embodiment of the present invention;

FIG. 5 is the top view of the image capture apparatus according to an exemplary embodiment of the present invention;

FIG. 6 is the bottom view of the image capture apparatus according to an exemplary embodiment of the present invention;

FIGS. 7-10 are the perspective views of the image capture apparatus according to an exemplary embodiment of the present invention from different angles.

### DETAILED DESCRIPTION OF THE INVENTION

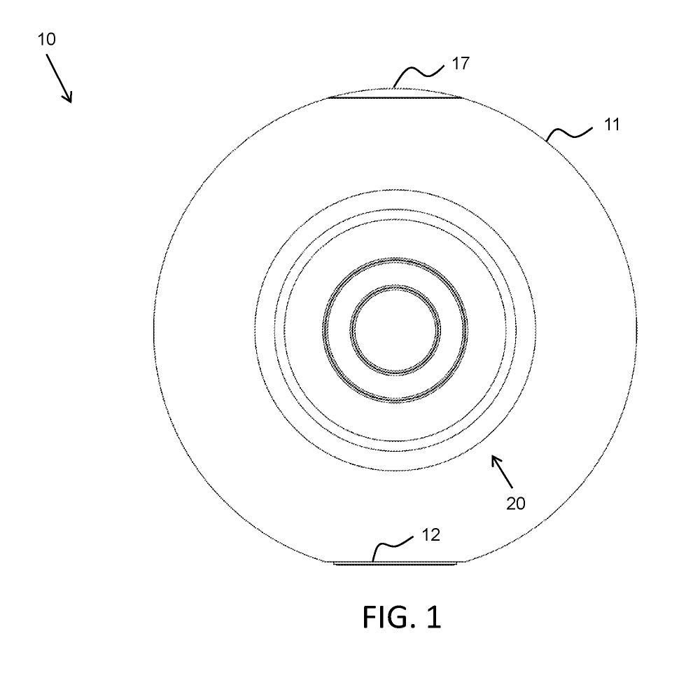

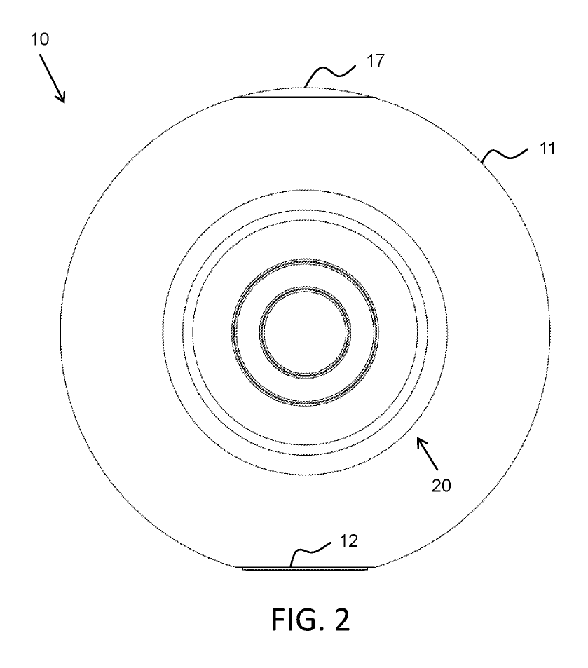

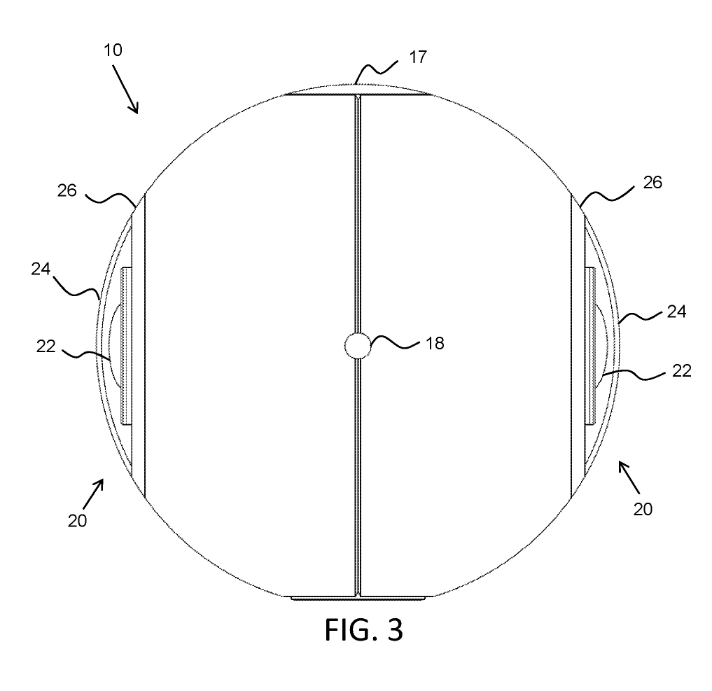

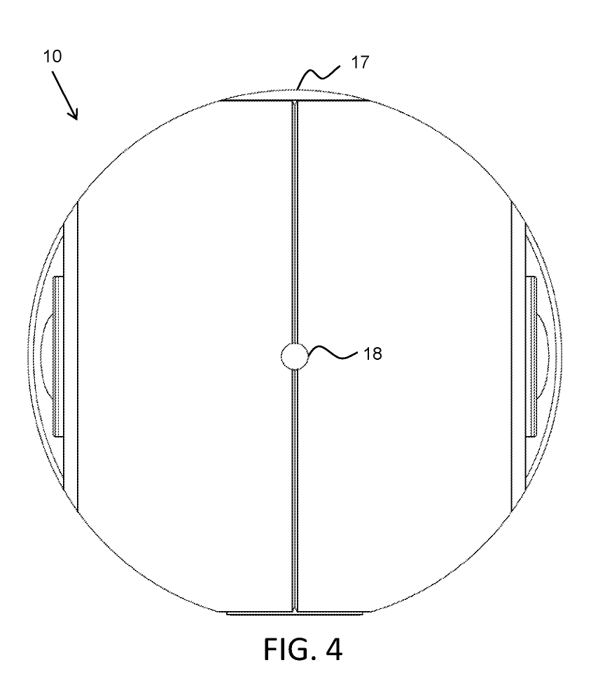

FIGS. 1 and 2 show respectively the front view and the back view of the image capture apparatus 10 according to an exemplary embodiment of the present invention, while FIGS. 3 and 4 show respectively the left view and the right view of the image capture apparatus 10. Note that in this particular embodiment, the front view and the back view are basically the same, and the left view and the right view are basically identical too. However, the present invention is not limited to this embodiment. In other words, the front view and the back could be different and the left view and the right view could be different in other embodiments.

As show in FIGS. 1-4, the image capture apparatus 10 has a substantially spherical housing 11 and two cameras 20. Particularly, the housing 11 has a flat bottom 12, and two cameras 20 are positioned above the flat bottom 12 and substantially opposite to each other in the housing. As shown, except the flat bottom 12, the housing 11 basically is formed by a smoothly spherical surface, which allows the image capture apparatus 10 to roll or rotate like a billiard ball. The area of the flat bottom 12 is smaller than ¼, preferably smaller than 1/9 the largest cross section of the housing 11. Also note that the flat bottom 12 has a round edge as illustrated, but the present invention is not limited to it.

Two identical cameras 20 are provided in this embodiment, but they could be different in other embodiments. For example, they could have different maximum resolutions or different field of view. Preferably each camera 20 has a fish-eye lens 22 or a wide angle lens. In the case where the cameras 20 do not have wide angle lens or where only one camera 20 is used, the camera(s) 20 could take a series of pictures from different view points when the image capture apparatus 10 is rolling or rotating, so as to still be able to obtain a 360 degree picture by “stitching” processing.

On the other hand, in the preferred embodiment where the image capture apparatus 10 has exactly two cameras 20, each camera 20 has a fish-eye lens 22 with a field of view of 190 degree and points in directions opposite to each other and substantially horizontally with the flat bottom 12. Together the two cameras 20 achieve a sum of the field of view as larger than 360 degree without the need of rolling or rotating of the image capture apparatus 10. Therefore, even if the image capture apparatus 10 stands still (i.e., rather than roll or rotate), a 360 degree picture or video could be obtained by stitching the pictures taken separately by the two cameras 20. Note that the invention is not limited to this embodiment, and the presented image capture apparatus can have more cameras, e.g., 4 cameras, in other embodiments.

Meanwhile, as shown in FIGS. 3 and 4, since the image capture apparatus 10 is designed to be rolled or rotated, the cameras 20 can have transparent lens covers 24 to protect the lens 22. The lens cover 24 could be scratch-proof, and/or could be replaceable when there are scratches. In one embodiment, the lens cover 24 may have a curved surface in order to match the spherical surface of the housing 11, as shown in FIGS. 3 and 4. However, due to optical considerations, the lens cover 24 could be more or less curved than the spherical surface of the housing 11.

The image capture apparatus 10 can have status indicators 18 on the housing 11, as shown in FIGS. 3 and 4, to indicate the operating status to the user. The status indicator 18 could be just a tiny LED so that it will not inference with the spherical surface of the housing 11. Alternatively, if there are more data to be shown to the user, the tiny LED could be replaced with a LCD or LED display (not shown). In such case, a curved screen is preferred in order to match the spherical surface of the housing 11.

Also as shown in FIGS. 1-4, for the assembling purpose, there could be rings 26 on the housing to surround the lens 22 and the lens cover 24. Preferably, the ring 26 constitutes part of an antenna. This arrangement is helpful when the image capture apparatus 10 has the capability of wireless communication but with a metal housing 11, which limits the freedom of antenna design due to the shielding and interference. Using the exposed ring 26 as the antenna may encounter less shielding and interference problems, compared with having the antenna completely embedded inside the housing 11.

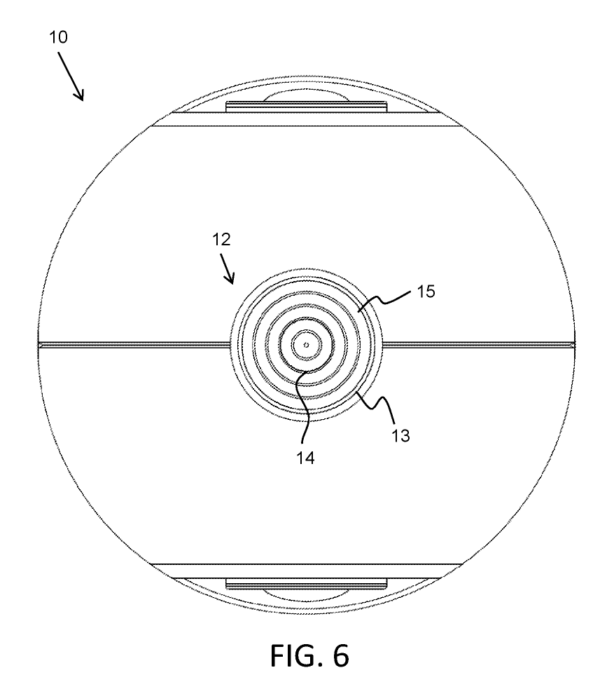

Now turn to FIG. 6, showing the bottom 12 in more details. As shown, connection grooves 13, or similar connection holes (not shown) are provided on the bottom 12, and could be used to connect to a pod (not shown). Note that the grooves 13 could be also positioned just right above the flat bottom 12 in a non-illustrated embodiment. Alternatively, a magnetic connector 15 is provided on the bottom 12, and could be used to attach to a metal object or another magnetic connector (both not shown) in an easily removable way. Meanwhile electrical contacts 14 are provided on the bottom 12 and could be used as data I/O ports to other electronic devices such as mobile phones or projectors (not shown), and/or for power charging purpose.

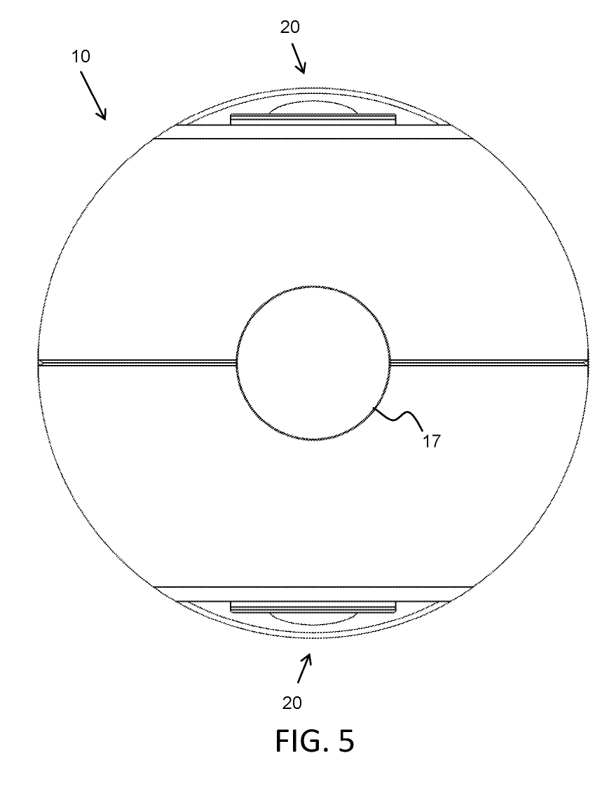

Further as shown in FIG. 5, showing a button 17 at the top of the image capture apparatus 10. The button 17 allows the user to control the image capture apparatus 10. Particularly, the position of the button 17, as opposite to the bottom 12, is helpful for the user to press downwardly when the image capture apparatus 10 stands still on a table (not shown) with the bottom 12, without causing unintended horizontal movement of the image capture apparatus 10 accidentally. Meanwhile, the button 17 may have a curved surface in order to match the spherical surface of the housing 11.

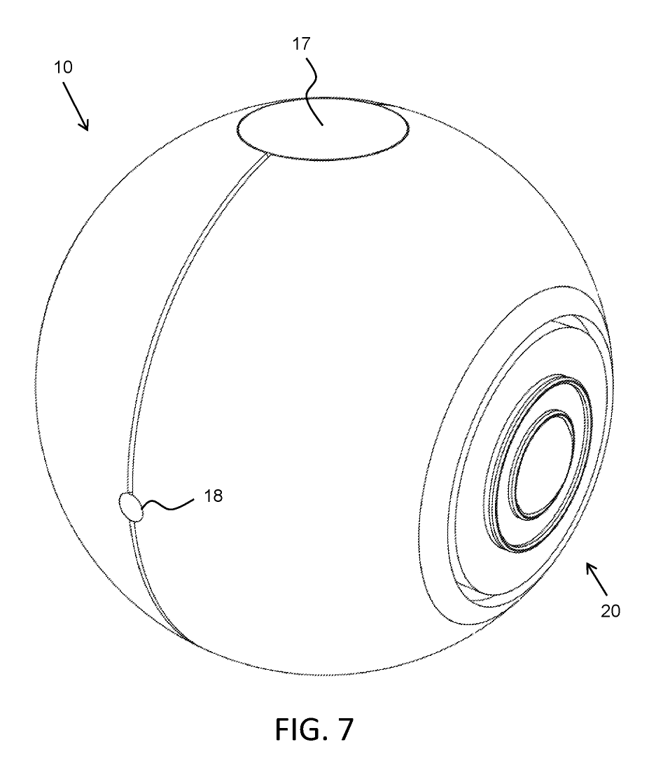

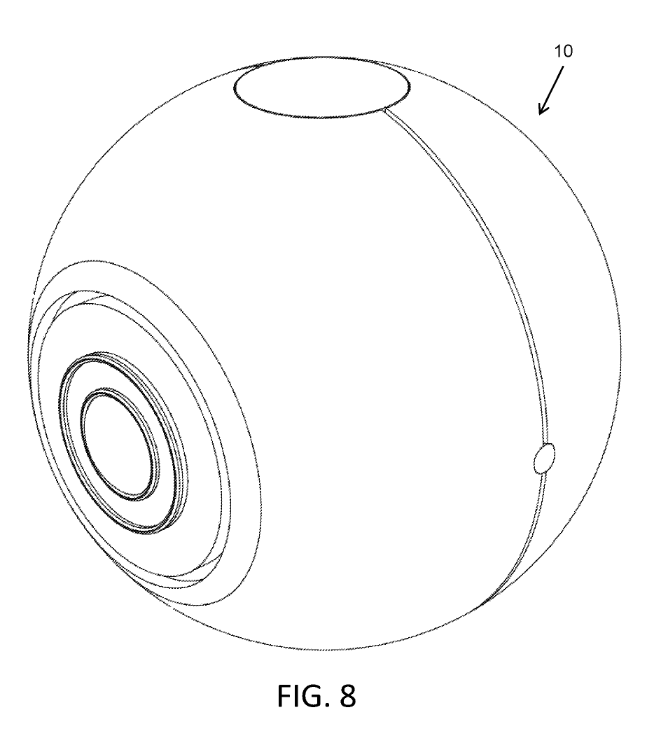

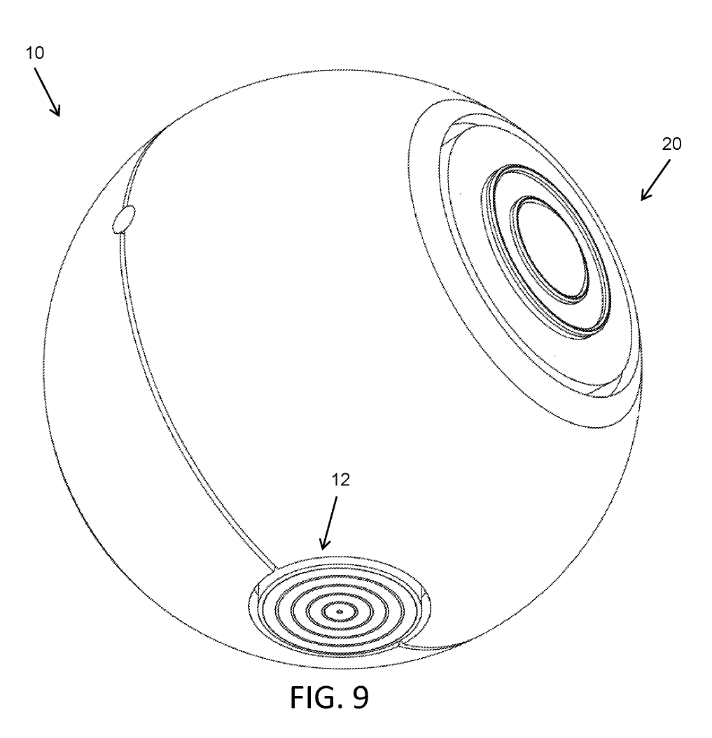

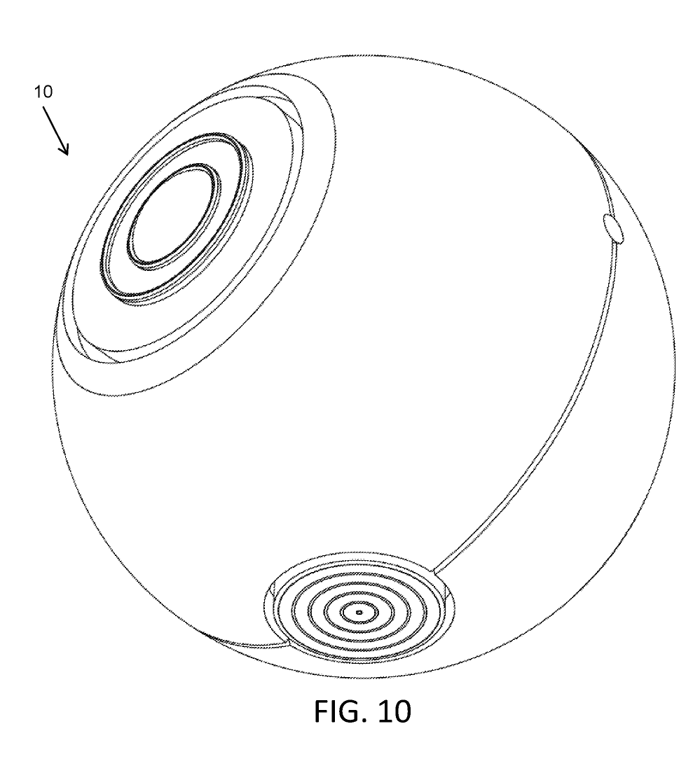

FIGS. 7-10 are the perspective views of the image capture apparatus according to an exemplary embodiment of the present invention from different angles and are provided for better understanding of the present invention.

One example of the presented image capture apparatus could be further referred to the Luna camera designed by Memora Inc. However, please note that the present invention is not limited to the Luna camera.

Just take the Luna camera for example, those skilled in the art should be able to realize that the presented image capture apparatus could be implemented as just 3 to 7 cm in diameter and weighing just over 180 g. It could also have wi-fi capability to allow the user to interactively preview 360° footage on his/her smartphone, immediately and wirelessly save it on his/her devices, share it on social media, and even live-stream moments in 360°. With certain accessories and mobile app, the user can even view the videos in immersive virtual reality.

In a non-illustrated application, an image capture apparatus includes:
a substantially spherical housing suitable for being rolled on a surface or the ground, wherein the housing is made of anti-abrasion materials; wherein the housing is water-proof; wherein the housing has a flat portion, so that the housing can stand still with the flat portion on a plane surface, and the area of the flat portion is smaller than ¼ the largest cross section of the housing, wherein the diameter of the largest cross section of the housing is around 3 cm, 5 cm, 6 cm, or 7 cm;
an attaching device, such as a magnetic plate, positioned on the flat portion so that the apparatus could be attached to another item, such as a power dock or a projector, with the attaching device, wherein the attaching device further has contact electrodes for receiving charging power and/or an external control signal and/or an external sensing signal provided by the another item, while the power dock can have its own processing circuit to send out the external control signal and sensors for the external sensing signal or in some cases the power dock is a mini computer running an OS;
at least two cameras positioned substantially opposite to each other in the housing, wherein each lens cover is replaceable or scratch-proof (such as Corning® Gorilla® Glass); wherein each camera has a field of view of at least 185° or preferably at least 190°;
a control unit, which could be implemented as a processor or an IC chip, in response to a user instruction or the external control signal received through the attaching device, to control a first camera to capture a first image and a second camera to capture a second image at substantially the same time, wherein the first image and the second image have overlapping portions to facilitate subsequent feature point stitching, wherein when the first camera and the second camera are equipped with the fish-eye lenses, the control unit further de-warps or preliminarily corrects the first image and the second image;
at least one sensor disposed within the housing, wherein the sensor generates a sensing signal for the first image or the second image, wherein the sensor could be selected from the group of accelerometer, position sensor, Gyro sensor, Depth sensor, Tilt sensor, Voice detector, Light sensor, Vibrate sensor, Proximity Sensor, Temperature sensor, and Swipe/slide sensor;
wherein:
   (i) the control unit can output through the attaching device, the first image, the second image, and the sensing signal together to the another item for further processing, transmission, and/or displaying at least part of the first image or the second image, and the attaching device can receive charging power at the same time; and/or
   (ii) the apparatus further comprises a wireless data outputting unit to output wirelessly in real time, the first image, the second image, the sensing signal and/or the external sensing signal together to a user device or to a cloud service for processing to generate a video, particularly a 360° video, wherein the user device or the cloud service processes the first image and the second image in a way dependent on the sensing signal and/or the external sensing signal; and/or
   (iii) the apparatus further comprises a display unit, which smoothly fits the spherical house so as not to prevent the rolling of the apparatus, and the control unit can output in real time, at least part of the first image or the second image to the display unit for display; and/or
   (iv) the apparatus further comprises a motor disposed within the housing, the motor driving or vibrating in response to a user command or the external control signal or the sensing signal.

An image capture system can include the image capture apparatus mentioned above and a user device or a cloud service. To generate video from the captured images, the user device or the cloud service processes the first image and the second image in a way dependent on the sensing signal and/or the external sensing signal. The user device could be a mobile phone, for example. Image processing such as feature-point stitching of two or more images and encoding is mainly handled by the user device or the cloud service, both of which have great processing power nowadays, so that the processing circuit of the presented image capture apparatus could be simple and easy to implement as well as low power consuming and less heat generating, compared with the conventional cameras bearing substantial image processing task and video encoding with its own processing circuit, such as taught by US20130210563 and Ricoh Theta S camera.

Note that in an embodiment, the processing circuit of the presented image capture apparatus can provide image de-warp for fish-eye lens or preliminary, i.e., light-weight, image processing, particularly to correct the lens aberration or other intrinsic lens errors.

1. An image capture apparatus comprising:
a substantially spherical housing, wherein the housing has a flat bottom, so that the image capture apparatus can stand still with the flat bottom on a plane surface, and the area of the flat bottom is smaller than ¼ the largest cross section of the housing; and
two cameras positioned above the flat bottom and substantially opposite to each other in the housing.

2. The image capture apparatus of claim 1, wherein the area of the flat bottom is smaller than 1/9 the largest cross section of the housing.

3. The image capture apparatus of claim 1, wherein the two cameras point substantially horizontally with the flat bottom.

4. The image capture apparatus of claim 1, wherein the two cameras each has a fish-eye lens.

5. The image capture apparatus of claim 1, wherein the sum of the field of view of the two cameras is at least 360°.

6. The image capture apparatus of claim 1, further comprising:
for at least one camera, a replaceable lens cover or a scratch-proof lens cover.

7. The image capture apparatus of claim 1, further comprising:
for at least one camera, a ring is provided on the housing to surround the lens of the camera; wherein the ring constitutes part of an antenna for wireless communication.

8. The image capture apparatus of claim 7, wherein the housing is a metal housing.

9. The image capture apparatus of claim 1, wherein the image capture apparatus comprises exactly two cameras.

10. The image capture apparatus of claim 1, further comprising:
an attaching device positioned at or around the flat bottom so that the image capture apparatus could be attached to another item with the attaching device.

11. The image capture apparatus of claim 10, wherein the attaching device is a magnetic connector.

12. The image capture apparatus of claim 11, further comprising:
electrical contacts at the flat bottom.

13. The image capture apparatus of claim 10, further comprising:
electrical contacts at the flat bottom.

14. The image capture apparatus of claim 1, further comprising:
electrical contacts at the flat bottom.

15. The image capture apparatus of claim 14, wherein said electrical contacts are provided for data I/O purpose.

16. The image capture apparatus of claim 15, wherein said electrical contacts are also provided for power charging purpose.

17. The image capture apparatus of claim 1, further comprising:
a button positioned at the top of the housing.

18. The image capture apparatus of claim 1, further comprising:
a status indicator or a display disposed on the housing.
